(19) United States
(12) Patent Application Publication
(10) Pub. No.: US 2008/0172287 A1
(43) Pub. Date: Jul. 17, 2008

(54) Automated Domain Determination in Business Logic Applications

(76) Inventors: Ian Tien, Seattle, WA (US); Corey Hulen, Sammamish, WA (US); Chen-I Lim, Bellevue, WA (US); Catalin Tomai, Bellevue, WA (US)

Correspondence Address: Carl K. Turk;Merchant & Gould P.C., P.O. Box 2903, Minneapolis, MN, 55402-0903, US

(21) Appl. No.: 11/624,122

(22) Filed: Jan. 17, 2007

(51) Int. Cl. G06Q 10/00

(52) U.S. Cl. 705/10

(57) ABSTRACT

Data ranges (domains) for statistical analysis of performance metrics are determined automatically based on user inputs for ending and starting periods. User interfaces are provided with allowances for addressing missing data in a consistent manner and for creating analyties over different time domains such as fiscal and Gregorian calendar measurements. Previews of analysis may be provided for visualization of data range parameter selections. Selections may be made explicitly or dynamically using textual or graphical user interface elements.

### BACKGROUND

Key Performance Indicators (KPIs) are quantifiable measurements that reflect the critical success factors of an organization ranging from income that comes from return customers to percentage of customer calls answered in the first minute. Key Performance Indicators may also be used to measure performance in other types of organizations such as schools, social service organizations, and the like. Measures employed as KPI within an organization may include a variety of types such as revenue in currency, growth or decrease of a measure in percentage, actual values of a measurable quantity, and the like.

The ability to analyze the historical performance of data with the potential to impact the strategic performance of an enterprise is often a mission critical task. However, tools and automation available for this analysis are relatively scarce. Businesses typically rely on a precarious system of manually authored trend analysis based on data pasted into spreadsheets for ad hoc analysis. When data is missing or potentially erroneous, assumptions and changes are made on the spot, which can violate data integrity, introduce inconsistency and cause serious error.

### SUMMARY

This summary is provided to introduce a selection of concepts in a simplified form that are further described below in the Detailed Description. This summary is not intended to identify key features or essential features of the claimed subject matter, nor is it intended as an aid in determining the scope of the claimed subject matter.

Embodiments are directed to automated determination of data ranges (domains) in generation of trend analysis based on performance metrics providing the ability to address missing data in a consistent manner and to create analytics over different time domains. Different forms of starting and end period selection for determining the domain may be provided to a user such as explicit selection, dynamic selection, and the like.

These and other features and advantages will be apparent from a reading of the following detailed description and a review of the associated drawings. It is to be understood that both the foregoing general description and the following detailed description are explanatory only and are not restrictive of aspects as claimed.

### BRIEF DESCRIPTION OF THE DRAWINGS

FIG. 1 illustrates an example scorecard architecture according to aspects;

FIG. 2 illustrates a screenshot of an example scorecard;

FIG. 3 is a screenshot of an example scorecard with an accompanying trend analysis chart;

FIG. 4 illustrates an example user interface for ending period selection with collapsible tree listing;

FIG. 5 illustrates an example user interface for dynamic ending period selection;

FIG. 6 illustrates an example user interface for selecting a data range as part of trend analysis in a scorecard application;

FIG. 7 illustrates another example user interface for selecting a data range as part of trend analysis in a scorecard application;

FIG. 8 illustrates an example user interface for data range selection using sliders;

FIG. 9 illustrates implementation of automated domain determination in a networked system;

FIG. 10 is a block diagram of an example computing device operating environment, where embodiments may be implemented; and

FIG. 11 illustrates a logic flow diagram for a process of automated domain determination in a business logic application.

### DETAILED DESCRIPTION

As briefly described above, data range(s) may be automatically determined in generating trend analysis based on performance metrics. In the following detailed description, references are made to the accompanying drawings that form a part hereof, and in which are shown by way of illustrations specific embodiments or examples. These aspects may be combined, other aspects may be utilized, and structural changes may be made without departing from the spirit or scope of the present disclosure. The following detailed description is therefore not to be taken in a limiting sense, and the scope of the present invention is defined by the appended claims and their equivalents.

While the embodiments will be described in the general context of program modules that execute in conjunction with an application program that runs on an operating system on a personal computer, those skilled in the art will recognize that aspects may also be implemented in combination with other program modules.

Generally, program modules include routines, programs, components, data structures, and other types of structures that perform particular tasks or implement particular abstract data types. Moreover, those skilled in the art will appreciate that embodiments may be practiced with other computer system configurations, including hand-held devices, multiprocessor systems, microprocessor-based or programmable consumer electronics, minicomputers, mainframe computers, and the like. Embodiments may also be practiced in distributed computing environments where tasks are performed by remote processing devices that are linked through a communications network. In a distributed computing environment, program modules may be located in both local and remote memory storage devices.

Embodiments may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process.

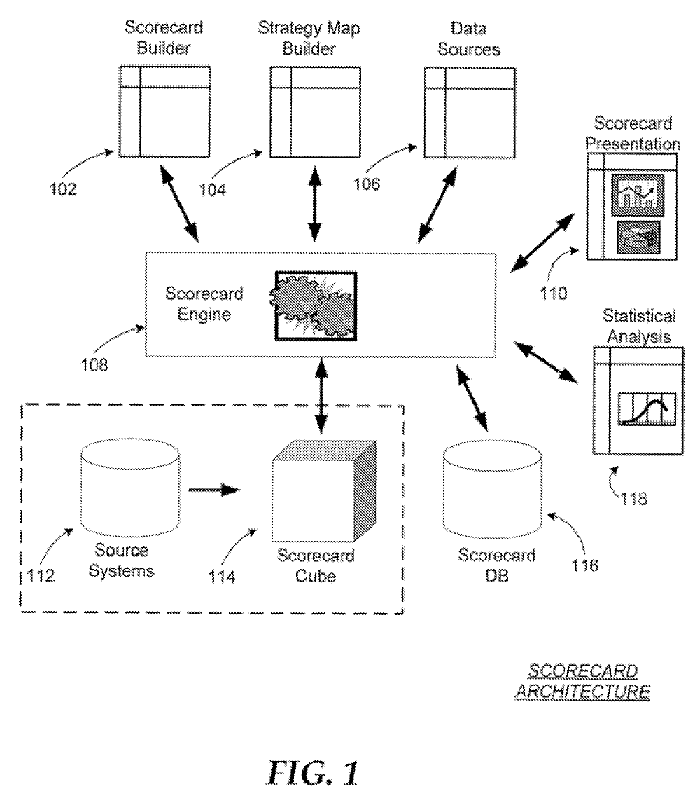

Referring to FIG. 1, an example scorecard architecture is illustrated. The scorecard architecture may comprise any topology of processing systems, storage systems, source systems, and configuration systems. The scorecard architecture may also have a static or dynamic topology.

Scorecards are an easy method of evaluating organizational performance. The performance measures may vary from financial data such as sales growth to service information such as customer complaints. In a non-business environment, student performances and teacher assessments may be another example of performance measures that can employ scorecards for evaluating organizational performance. In the exemplary scorecard architecture, a core of the system is scorecard engine 108. Scorecard engine 108 may be an application software that is arranged to evaluate performance metrics. Scorecard engine 108 may be loaded into a server, executed over a distributed network, executed in a client device, and the like.

Data for evaluating various measures may be provided by a data source. The data source may include source systems 112, which provide data to a scorecard cube 114. Source systems 112 may include multi-dimensional databases such OLAP, other databases, individual files, and the like, that provide raw data for generation of scorecards. Scorecard cube 114 is a multi-dimensional database for storing data to be used in determining Key Performance Indicators (KPIs) as well as generated scorecards themselves. As discussed above, the multi-dimensional nature of scorecard cube 114 enables storage, use, and presentation of data over multiple dimensions such as compound performance indicators for different geographic areas, organizational groups, or even for different time intervals. Scorecard cube 114 has a bi-directional interaction with scorecard engine 108 providing and receiving raw data as well as generated scorecards.

Scorecard database 116 is arranged to operate in a similar manner to scorecard cube 114. In one embodiment, scorecard database 116 may be an external database providing redundant back-up database service.

Scorecard builder 102 may be a separate application or a part of a business logic application such as the performance evaluation application, and the like. Scorecard builder 102 is employed to configure various parameters of scorecard engine 108 such as scorecard elements, default values for actuals, targets, and the like. Scorecard builder 102 may include a user interface such as a web service, a GUI, and the like.

Strategy map builder 104 is employed for a later stage in scorecard generation process. As explained below, scores for KPIs and other metrics may be presented to a user in form of a strategy map. Strategy map builder 104 may include a user interface for selecting graphical formats, indicator elements, and other graphical parameters of the presentation.

Data Sources 106 may be another source for providing raw data to scorecard engine 108. Data sources 106 may also define KPI mappings and other associated data.

Additionally, the scorecard architecture may include scorecard presentation 110. This may be an application to deploy scorecards, customize views, coordinate distribution of scorecard data, and process web-specific applications associated with the performance evaluation process. For example, scorecard presentation 110 may include a web-based printing system, an email distribution system, and the like. In some embodiments, scorecard presentation 110 may be an interface that is used as part of the scorecard engine to export data for generating presentations or other forms of scorecard-related documents in an external application. For example, metrics, reports, and other elements (e.g. commentary) may be provided with metadata to a presentation application (e.g. PowerPoint® of MICROSOFT CORPORATION of Redmond, Wash.), a word processing application, or a graphics application to generate slides, documents, images, and the like, based on the selected scorecard data.

Moreover, the scorecard architecture may include statistical analysis 118. Statistical analysis 118 may be a separate application or a module integrated into the architecture for performing statistical analysis on scorecard data such as tend prediction. A scorecard may comprise a large number of elements with complex interrelations. In some cases, it may be difficult for a subscriber to analyze the elements in various combinations or detect correlations. Data mining applications may be a useful tool in such cases determining correlative relationships between elements based on subscriber provided configurations. Statistical analysis 118 may also interact with scorecard presentation 110 enabling the subscriber to configure presentation parameters for results of the statistical analysis. A significant aspect of statistical analysis based on performance metrics is determination of the data range, typically along a time dimension.

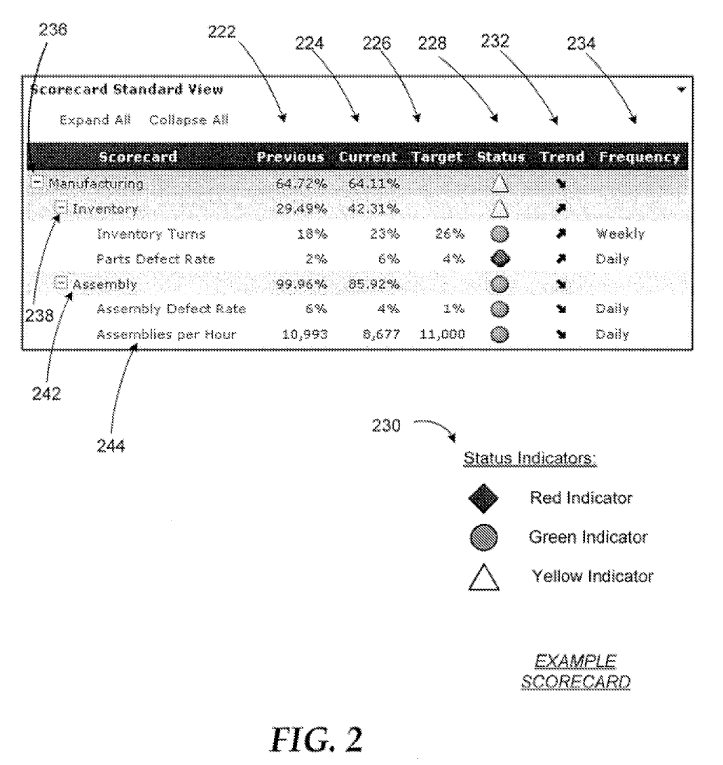

FIG. 2 illustrates a screenshot of an example scorecard with status indicators 230. As explained before, Key Performance Indicators (KPIs) are specific indicators of organizational performance that measure a current stat in relation to meeting the targeted objectives. Decision makers may utilize these indicators to manage the organization more effectively.

When creating a KPI, the KPI definition may be used across several scorecards. This is useful when different scorecard managers might have a shared KPI in common. This may ensure a standard definition is used for that KPI. Despite the shared definition, each individual scorecard may utilize a different data source and data mappings for the actual KPI.

Each KPI may include a number of attributes. Some of these attributes include frequency of data, unit of measure, trend type, weight, and other attributes.

The frequency of data identifies how often the data is updated in the source database (cube). The frequency of data may include: Daily, Weekly, Monthly, Quarterly, and Annually.

The unit of measure provides an interpretation for the KPI. Some of the units of measure are: Integer, Decimal, Percent, Days, and Currency. These examples are not exhaustive, and other elements may be added without departing from the scope of the invention.

A trend type may be set according to whether an increasing trend is desirable or not. For example, increasing profit is a desirable trend, while increasing defect rates is not. The trend type may be used in determining the KPI status to display and in setting and interpreting the KPI banding boundary values. The arrows displayed in the scorecard of FIG. 2 indicate how the numbers are moving this period compared to last. If in this period the number is greater than last period, the trend is up regardless of the trend type. Possible trend types may include: Increasing Is Better, Decreasing Is Better, and On-Target Is Better.

Weight is a positive integer used to qualify the relative value of a KPI in relation to other KPIs. It is used to calculate the aggregated scorecard value. For example, if an Objective in a scorecard has two KPIs, the first KPI has a weight of 1, and the second has a weight of 3 the second KPI is essentially three times more important than the first, and this weighted relationship is part of the calculation when the KPIs' values are rolled up to derive the values of their parent metric.

Other attributes may contain pointers to custom attributes that may be created for documentation purposes or used for various other aspects of the scorecard system such as creating different views in different graphical representations of the finished scorecard. Custom attributes may be created for any scorecard element and may be extended or customized by application developers or users for use in their own applications. They may be any of a number of types including text, numbers, percentages, dates, and hyperlinks.

One of the benefits of defining a scorecard is the ability to easily quantify and visualize performance in meeting organizational strategy. By providing a status at an overall scorecard level, and for each perspective, each objective or each KPI rollup, one may quickly identify where one might be off target. By utilizing the hierarchical scorecard definition along with KPI weightings, a status value is calculated at each level of the scorecard.

First column of the scorecard shows example top level metric 236 “Manufacturing” with its reporting KPIs 238 and 242 “Inventory” and “Assembly”. Second column 222 in the scorecard shows results for each measure from a previous measurement period. Third column 224 shows results for the same measures for the current measurement period. In one embodiment, the measurement period may include a month, a quarter, a tax year, a calendar year, and the like.

Fourth column 226 includes target values for specified KPIs on the scorecard. Target values may be retrieved from a database, entered by a user, and the like. Column 228 of the scorecard shows status indicators 230.

Status indicators 230 convey the state of the KPI. An indicator may have a predetermined number of levels. A traffic light is one of the most commonly used indicators. It represents a KPI with three-levels of results—Good, Neutral, and Bad. Traffic light indicators may be colored red, yellow, or green. In addition, each colored indicator may have its own unique shape. A KPI may have one stoplight indicator visible at any given time. Other types of indicators may also be employed to provide status feedback. For example, indicators with more than three levels may appear as a bar divided into sections, or bands. Column 232 includes trend type arrows as explained above under KPI attributes. Column 234 shows another KPI attribute, frequency.

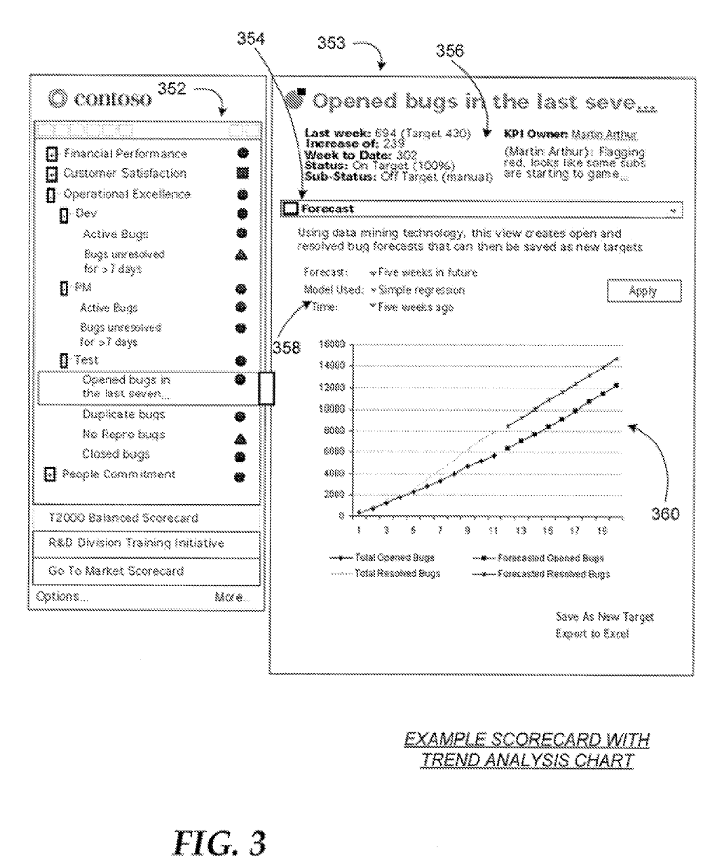

FIG. 3 is a screenshot of an example scorecard with an accompanying trend analysis chart. The example screenshot is part of a user interface of a scorecard application that may collect, process, and analyze performance data from various aspects of an organization.

One of the key challenges in using multi-dimensional data is providing users the ability to define the domain (commonly called the “x-axis”) of the data set to be charted particularly when the author of the chart is not the owner of the data source. For example, consider a time period that has been broken down to days, weeks, months, quarters, and years. Configuring the domain definition is not an intuitive task, particularly when a user might define a starting day and an ending month, or when an author wants to default a chart to a notion of “current” while allowing the end-viewer to see the data at different granularities (week, day, month, year, etc.). Moreover, there may be data missing or invalid for the given periods that may unnecessarily skew the report and may need to be appropriately accounted for.

As mentioned previously, data ranges (domains) may be determined automatically for generating trend analyses based on performance metrics with allowances for addressing missing data in a consistent manner and for creating analytics over different time domains such as fiscal and Gregorian calendar measurements. The automated generation of historical performance analysis in this manner may increase reporting consistency, reduce errors, and may lead to increased reliability in automated data analysis.

Example scorecard 352 in the figure includes various levels of performance metrics (KPIs) such as “Financial Performance”, “Customer Satisfaction”, and “Test”. The reporting structure of the metrics as illustrated by the collapsible tree format. Next to each metric is a status indicator displayed using the traffic light format as described in conjunction with FIG. 2. The user interface enables users to select among the metrics. In the example the metric “Opened bugs in the last seven . . . ” reporting to the higher level metric “Test” is selected.

Selecting a metric is one of the early steps in a statistical analysis process. In a typical business logic application, subscribers may have access to a plurality of metrics associated with a scorecard. Each metric may have various sets of actuals, targets, and the like. Moreover, each metric may be associated with a number of data sources, such as spreadsheets, SQL databases, data cubes, document libraries, and the like, as described previously. Thus, the analysis may involve retrieval of data from multiple data sources.

Report view 353 illustrates summary information 356 and trend analysis chart 360 for the selected metric on scorecard 352. In the example report view, summary information 356 includes KPI owner information, last week's performance summary, and the status of actual versus target for the last week, and the like. Trend analysis chart 360 includes graphs of opened bugs (in a software test setting) over a ten week period with five weeks in the past and five weeks forecasted in the future. The time periods and analysis model used for the chart are given in chart annotation 358. A drop-down menu 354 indicates that the chart is for forecasting the trend of the selected metric. As the figure illustrates, the data range or domain for the trend analysis is a critical component of metric based analysis. How the domain is specified in a user interface for defining parameters for the analysis play an important role. As discussed below, different techniques may be employed for enabling a user to specify parameters associated with the domain such as an ending period or a start period and the domain determined from the user input.

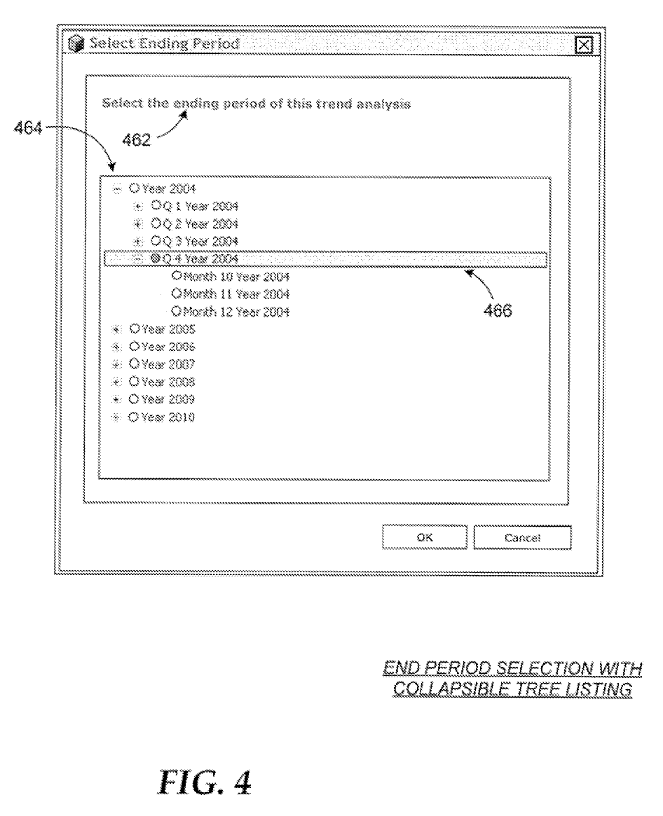

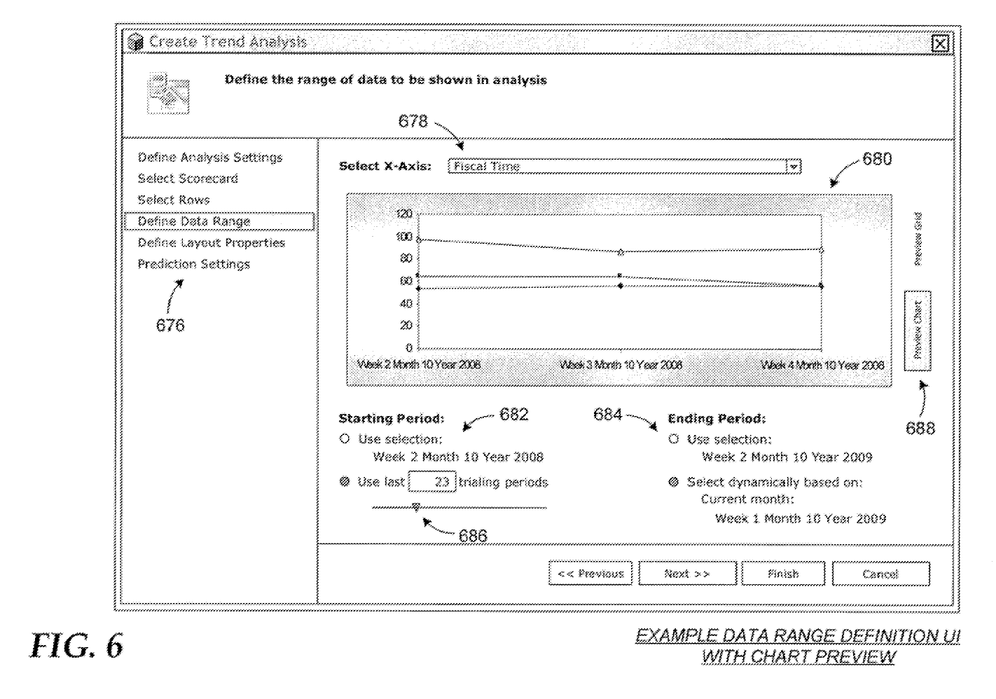

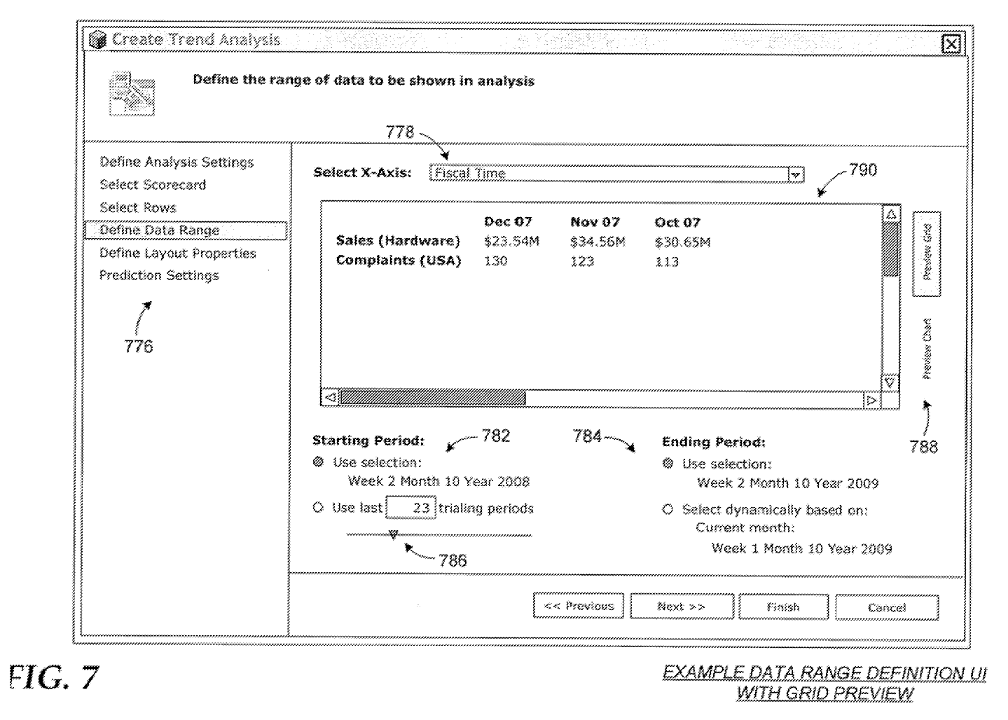

FIG. 4 illustrates an example user interface for ending period selection with collapsible tree listing. Details of how a domain for statistical analysis may be determined from user input for start and ending periods in a performance metrics application are discussed in conjunction with FIG. 6 and FIG. 7. Typically, user input for determining a domain start with specification of an ending period for the analysis. The ending period in scorecard computations may be defined in a number of ways.

The example user interface user interface in FIG. 4 shows one such method, selection of an ending period using a collapsible tree listing. The user interface includes an explanation of the user interface “Select the ending period of this trend analysis” 462, the collapsible tree listing 464 and the selected ending period 466 (highlighted). One of the advantages of the collapsible tree listing is that it allows a visually enhanced presentation of available ending periods with granularity. For example, the top level tree listing may include only years, but each year may be expanded into quarters, months, weeks, and the like. Since a user is likely to expand only a year (and the levels underneath it) of interest, the listing fits easily on a single viewing screen. Furthermore, if the granularity levels are different for certain years (the metric of interest may be reports by month in some years and by quarter in others), the collapsible tree listing can accommodate that variation easily.

Another embodiment of selecting an ending period similar to the collapsible tree listing (not shown) is a user interface that provides the top level ending periods as a list of links, each link leading to a new screen for the lower level ending periods (e.g. months) and each of those links leading to yet another screen of their lower levels, and so on.

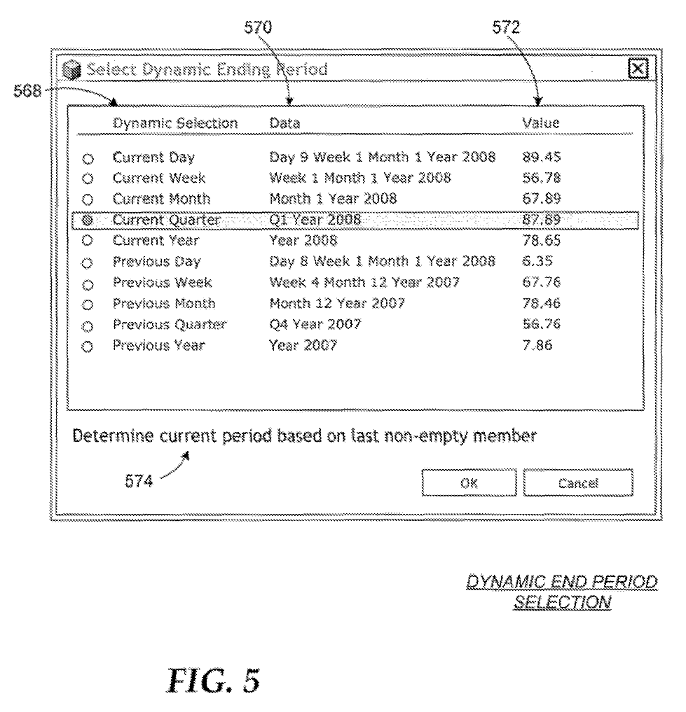

FIG. 5 illustrates an example user interface for dynamic ending period selection. Ending periods may also be selected by specifying a “current”, “previous”, or “next” period (year, quarter, month, etc.).

In the example user interface, first column 568 shows a list of available ending periods for dynamic selection. The second column 570 shows the corresponding actual time period (e.g. day 8 of week 7 of 2006). An optional third column 572 shows a value (value of the actual for the selected metric). The dynamic period may be determined based on a number of methods such as last non-empty member, next zero member, finding a member with a specific attribute, and the like. The computation method (574) is also listed in the user interface. In determining the current period using last-non empty member method a lag value may also be specified by the user allowing shifting of the period of interest into the past or into the future.

FIG. 6 illustrates an example user interface for selecting a data range as part of trend analysis in a scorecard application. The data range selection user interface includes a header section describing its functionality and a side panel listing of available steps with “Define Data Range” (676) highlighted.

The main panel of the user interface includes a drop-down menu selection 678 for indicating X-axis value (e.g. fiscal time in the illustrated example). Below the drop-down menu selection 678 is a preview 680 of the resulting chart displaying selected metrics along the selected X-axis dimension. According to embodiments, the preview may include a chart (as shown in this figure) or a grid view of the scorecard (as shown in the next figure). The selection between the preview types may be made through the preview selection buttons 688.

Under the preview 678 are starting period and ending period selections (682 and 684). According to some embodiments, the ending period selection 684 may be made by explicit selection or by dynamic selection. For explicit selection, the user may enter a specific period or select from a list of explicit periods (e.g. the collapsible tree list of FIG. 4). For dynamic selection a current, next, or previous period selection may be made, as described in conjunction with FIG. 5, and the corresponding actual period automatically determined by the data range engine. For the starting period 682, the user may also make an explicit selection or specify the starting period by entering a lag value and have it determined automatically based on the ending period and the lag. In the example user interface, a lag of 23 periods is specified by the user meaning the starting period is 23 weeks before the specified ending period of Week 1 of Month 10 of 2009.

According to other embodiments, the starting period may also be specified graphically using a slider on a timeline axis such as slider 686. The slider may be provided in conjunction with a textual indicator presenting the user the numeric value of lag corresponding to the slider position.

According to further embodiments, the data range selection user interface may include additional elements such as graphic or textual indicators of selected period type (week, month, year), an indication of whether the data range is for forecast (future) or performance analysis (past), and the like. The preview chart may be updated automatically based on user selections of ending and starting period.

A granularity level of the periods is typically determined by the selection of the ending period. The granularity level of the starting period may be automatically determined from the selection for the ending period. The domain and its granularity is then determined from the ending and starting periods. On the other hand, the user may be provided the ability to select different granularity levels for ending and starting periods. The data range engine may then determine a granularity for the domain by scaling also based on a granularity of the data source.

Following the selection of ending and starting periods and determination of the domain, another user interface (now shown) may be presented to enable the user to exclude periods. For example, a user may wish to exclude weekend days because no performance metric activity takes place on those days. Other reasons may include zero value periods, holidays, lack of data, and the like. The exclusion user interface may be a pop-up panel or a completely separate user interface. It may be in a collapsible tree format with selection boxes, text box format for explicit entry, or graphical selection format. Once the exclusion is completed, the analysis may be performed.

FIG. 7 illustrates another example user interface for selecting a data range as part of trend analysis in a scorecard application. The example user interface in FIG. 7 similar to the user interface of FIG. 6 with header section, listing of available elements 776 with “Define Data Range” highlighted, X-axis definition drop-down menu 778 and the preview region 790. Differently from the user interface of FIG. 6, however, the preview region in this figure includes a grid presentation for the selected scorecard metrics where the data range is numerically displayed as time dimension. When the ending and starting period selections (782 and 784) are made, the preview grid may be updates displaying the selected starting and ending periods. Ending and starting period selections are presented and made similar to the selections in FIG. 6 with the slider 786 being user to indicate lag value for the starting period. Other preview types such as a three dimensional visualization may also be included in the user interface.

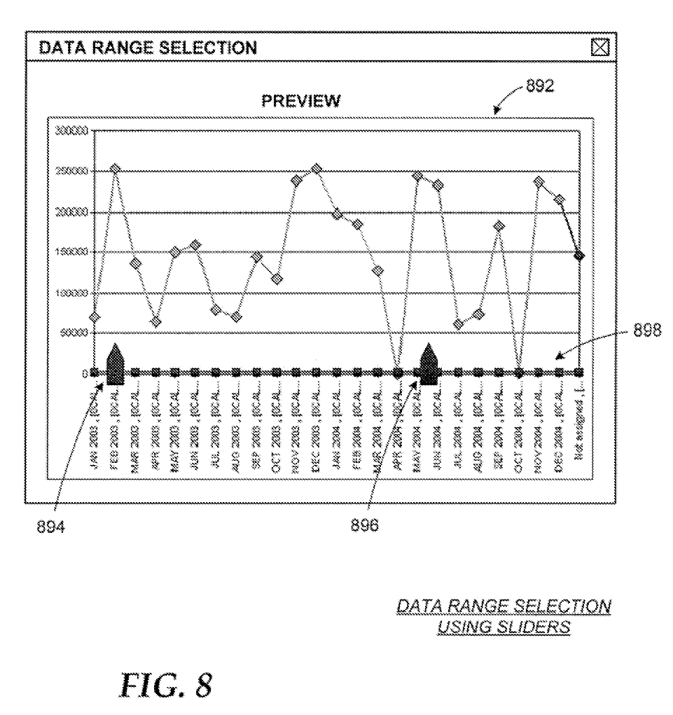

FIG. 8 illustrates an example user interface for data range selection using sliders. Sliders offer a graphical selection method for a data range (or domain) as shown in the figure. The data range selection user interface includes a preview 892 of the trend analysis chart. If no initial data points for the domain (e.g. historic usage, user profile, available data ranges, etc.) are available, a default domain may be used for the preview. A start period slider 894 and an ending period slider 896 are positions along time axis 898 of the preview chart. The user may be prompted to adjust a position of the sliders in order to specify the domain explicitly. To accommodate granularity, the time axis 989 may be expanded across the whole user interface or locally in selected regions. For example, in response to the user setting the sliders between December 2006 and February 2007 on a time axis with monthly markers, the granularity of the axis may be changed automatically to weekly allowing the user to select weeks instead of months.

The example data range selection approaches in the user interfaces of FIG. 4 through FIG. 8 are for illustration purposes only and do not constitute any limitation on embodiments. Other approaches using different configurations and user interface elements such as drop-down menus, icons, and the like, may be implemented using the principles described herein.

Embodiments are also not limited to the example user interfaces, layouts, elements, and operations discussed above. Many other types of operations may be performed and interfaces/layouts used to implement automatic determination of data ranges based on performance metrics using the principles described herein.

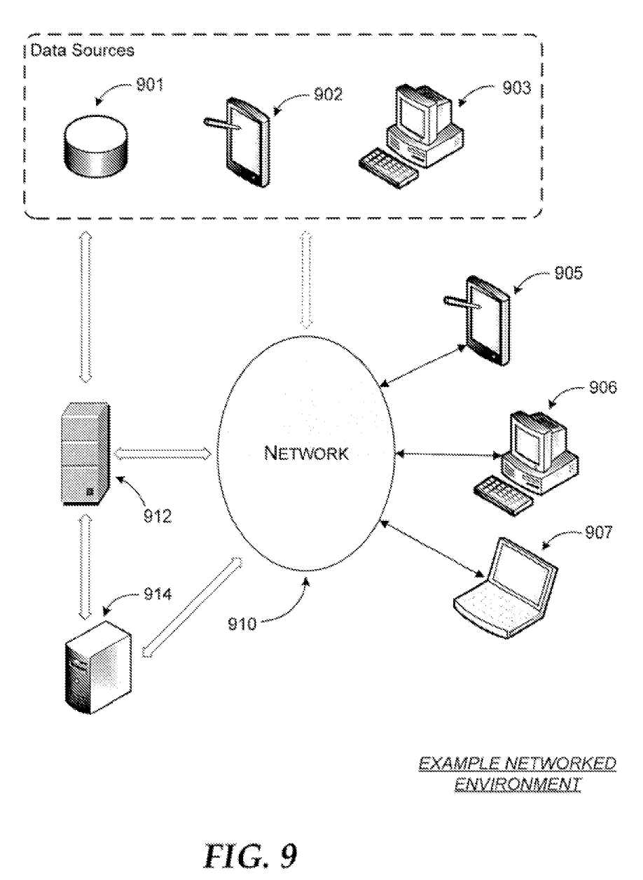

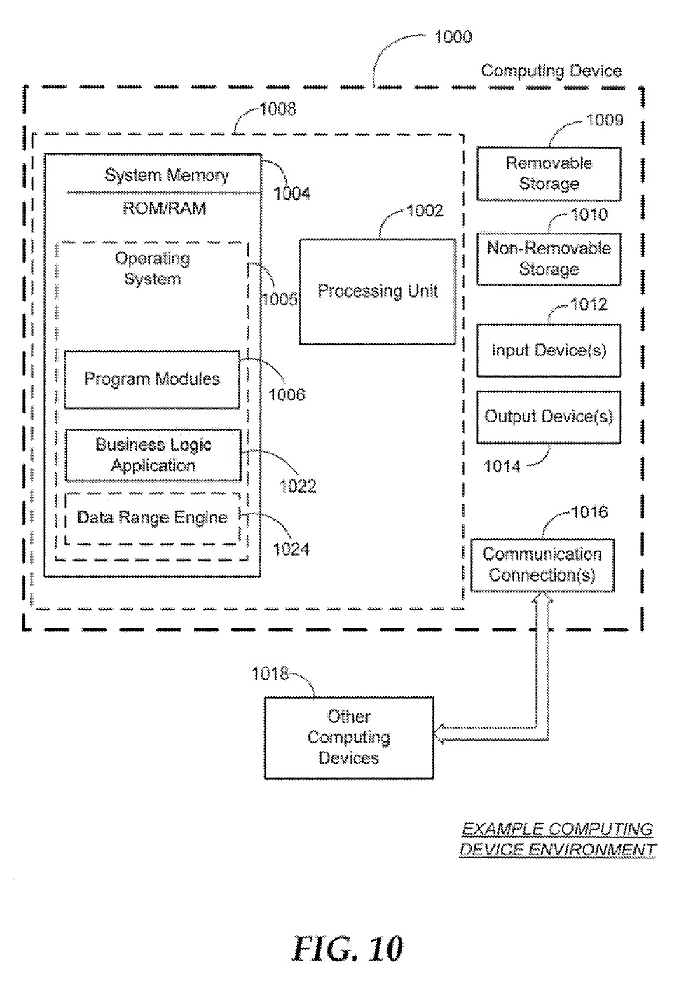

Referring now to the following figures, aspects and exemplary operating environments will be described. FIG. 9, FIG. 10, and the associated discussion are intended to provide a brief, general description of a suitable computing environment in which embodiments may be implemented.

FIG. 9 illustrates implementation of automated domain determination in a networked system. The system may comprise any topology of servers, clients, Internet service providers, and communication media. Also, the system may have a static or dynamic topology. The term “client” may refer to a client application or a client device employed by a user to perform operations associated with automated determination of domains. While a networked business logic system may involve many more components, relevant ones are discussed in conjunction with this figure.

In a typical operation according to embodiments, business logic service may be provided centrally from server 912 or in a distributed manner over several servers (e.g. servers 912 and 914) and/or client devices. Server 912 may include implementation of a number of information systems such as performance measures, business scorecards, and exception reporting. A number of organization-specific applications including, but not limited to, financial reporting/analysis, booking, marketing analysis, customer service, and manufacturing planning applications may also be configured, deployed, and shared in the networked system.

Data sources 901-903 are examples of a number of data sources that may provide input to server 912. Additional data sources may include SQL servers, databases, non multi-dimensional data sources such as text files or EXCEL® sheets, multi-dimensional data source such as data cubes, and the like.

Users may interact with server running the business logic service from client devices 905-907 over network 910. In another embodiment, users may directly access the data from server 912 and perform analysis on their own machines.

Client devices 905-907 or servers 912 and 914 may be in communications with additional client devices or additional servers over network 910. Network 910 may include a secure network such as an enterprise network, an unsecure network such as a wireless open network, or the Internet. Network 910 provides communication between the nodes described herein. By way of example, and not limitation, network 910 may include wired media such as a wired network or direct-wired connection, and wireless media such as acoustic, RF, infrared and other wireless media.

Many other configurations of computing devices, applications, data sources, data distribution and analysis systems may be employed to implement automatic determination of domains. Furthermore, the networked environments discussed in FIG. 9 are for illustration purposes only. Embodiments are not limited to the example applications, modules, or processes. A networked environment for may be provided in many other ways using the principles described herein.

With reference to FIG. 10, a block diagram of an example computing operating environment is illustrated, such as computing device 1000. In a basic configuration, the computing device 1000 typically includes at least one processing unit 1002 and system memory 1004. Computing device 1000 may include a plurality of processing units that cooperate in executing programs. Depending on the exact configuration and type of computing device, the system memory 1004 may be volatile (such as RAM), non-volatile (such as ROM, flash memory, etc.) or some combination of the two. System memory 1004 typically includes an operating system 1005 suitable for controlling the operation of a networked personal computer, such as the WINDOWS® operating systems from MICROSOFT CORPORATION of Redmond, Wash. The system memory 1004 may also include one or more software applications such as program modules 1006, business logic application 1022, and data range engine 1024.

Business logic application 1022 may be any application that processes and generates scorecards and associated data. Data range engine 1024 may be an integral part of business logic application 1022 or a separate module for determining a data range based on user input and applicable performance metrics. Data range engine 1024 may also operate remotely and communicate with the business logic application 1022 and with other applications running on computing device 1000 or on other devices. This basic configuration is illustrated in FIG. 10 by those components within dashed line 1008.

The computing device 1000 may have additional features or functionality. For example, the computing device 1000 may also include additional data storage devices (removable and/or non-removable) such as, for example, magnetic disks, optical disks, or tape. Such additional storage is illustrated in FIG. 10 by removable storage 1009 and non-removable storage 1010. Computer storage media may include volatile and nonvolatile, removable and non-removable media implemented in any method or technology for storage of information, such as computer readable instructions, data structures, program modules, or other data. System memory 1004, removable storage 1009 and non-removable storage 1001 are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing device 1000. Any such computer storage media may be part of device 1000. Computing device 1000 may also have input device(s) 1012 such as keyboard, mouse, pen, voice input device, touch input device, etc. Output device(s) 1014 such as a display, speakers, printer, etc. may also be included. These devices are well known in the art and need not be discussed at length here.

The computing device 1000 may also contain communication connections 1016 that allow the device to communicate with other computing devices 1018, such as over a network in a distributed computing environment, for example, an intranet or the Internet. Communication connection 1016 is one example of communication media. Communication media may typically be embodied by computer readable instructions, data structures, program modules, or other data in a modulated data signal, such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. The term computer readable media as used herein includes both storage media and communication media.

The claimed subject matter also includes methods. These methods can be implemented in any number of ways, including the structures described in this document. One such way is by machine operations, of devices of the type described in this document.

Another optional way is for one or more of the individual operations of the methods to be performed in conjunction with one or more human operators performing some. These human operators need not be collocated with each other, but each can be only with a machine that performs a portion of the program.

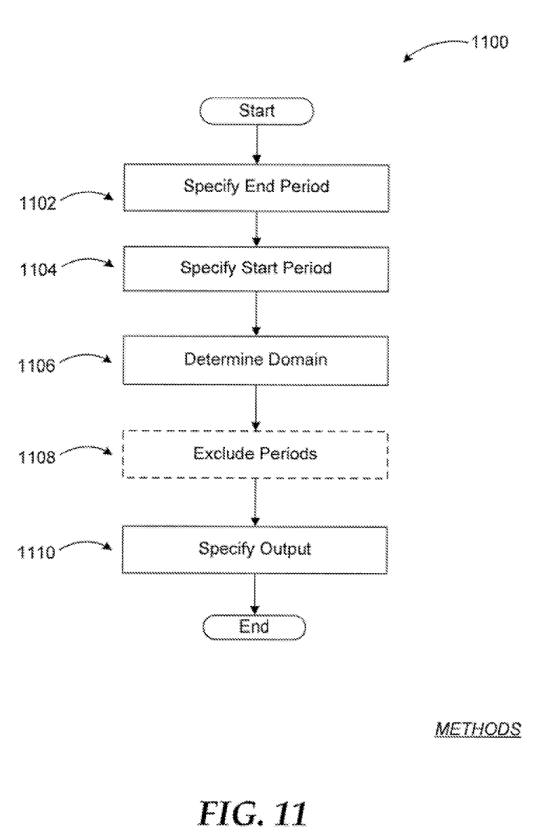

FIG. 11 illustrates a logic flow diagram for a process of automated domain determination in a business logic application. Process 1100 may be implemented in a business logic application that processes and/or generates scorecards and scorecard-related reports.

Process 1100 begins with operation 1102, where an ending period indication is received from a user. As described previously, the ending period may be specified explicitly or dynamically. Processing advances from operation 1102 to operation 1104.

At operation 1104, the starting period indication is received. The starting period may be specified also explicitly or by specifying a lag value from the specified ending period. A selection of starting period by the user may include explicit specification such as selection from a collapsible tree listing, a list of values, a textual representation of the intended selection (e.g. the user can enter “10/10/2007” into a text box), or a standard calendar control. A granularity level of the starting period may be determined from the granularity level of the ending period or the start and the end members may be specified at different granularity levels. A lag period at different levels may be determined by an approximation based on child members, an explicit definition based on member attributes, or a computation based on Gregorian calendar. Processing proceeds from operation 1104 to operation 1106.

At operation 1106, the domain for the analysis is determined from the starting and ending periods. The ending period may be determined based on detecting a last non-empty member of a specific dimension, detecting an attribute associated with a member from the data store, or receiving input about the period as a parameter to be determined at a later time (e.g. the period could be determined based on the preference profile of the person logging in to view the report in the case where users would “save” the time period they have navigated to after some analysis, the setting may be honored the next time the report is viewed by that user). If the starting and ending periods are at different granularity levels, the domain's granularity level may be determined automatically by scaling. Processing moves from operation 1106 to optional operation 1108.

At optional operation 1108, selected periods may be excluded from the domain. The exclusion may be accomplished by presenting the user an interface for graphically or textually selecting explicit periods (or period groups), allowing the user to enter explicit periods to be excluded, and the like. Processing advances from optional operation 1108 to operation 1110.

At operation 1110, an output of the analysis may be defined. The output, similar to a preview in the data range selection user interface, may be a chart, a grid, a three dimensional visualization. Furthermore, the output may be tied to attribute data associated with scorecard elements. The output may also be universal (in a distributed performance metric system) or localized. After operation 1110, processing moves to a calling process for further actions.

The operations included in process 1100 are for illustration purposes. Automatically determining domains for trend analysis based on performance metrics may be implemented by similar processes with fewer or additional steps, as well as in different order of operations using the principles described herein.

The above specification, examples and data provide a complete description of the manufacture and use of the composition of the embodiments. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims and embodiments.

What is claimed is:

1. A method to be executed at least in part in a computing device for automatically determining a domain for a performance metric based analysis, the method comprising:
receiving a user indication of an ending period for the domain,
receiving a user indication of a starting period for the domain,
automatically determining a granularity for the domain,
automatically determining the domain based on the starting period, the ending period, and the granularity;
receiving a user indication for at least one exclusion period; and
automatically adjusting the domain based on the at least one exclusion period.

2. The method of claim 1, further comprising:
providing the user a selection option for indicating the ending period by one of: an explicit specification and a dynamic specification.

3. The method of claim 2, wherein the selection option for the explicit specification includes selection from one of a collapsible tree listing, a list of values, a textual representation of intended selection, and a standard calendar control.

4. The method of claim 2, wherein the selection option for the dynamic specification includes selection from one of a current period, a previous period, and a next period.

5. The method of claim 4, further comprising:
determining an ending period based on at least one from a set of: detecting a last non-empty member of a specific dimension, detecting an attribute associated with a member from the data store, and receiving input about the period as a parameter to be determined at a later time.

6. The method of claim 1, further comprising:
providing the user a selection option for indicating the starting period by one of: an explicit specification and a dynamic lag period specification.

7. The method of claim 1, further comprising:
determining an actual lag period from the user specified dynamic lag period by one of: approximating based on child levels of lag periods, defining based on a lag period attribute, and computing based on calendar.

8. The method of claim 1, further comprising:
determining a granularity level of the starting period from a granularity level of the ending period.

9. The method of claim 1, wherein a granularity level of the ending period is different from a granularity level of the starting period.

10. The method of claim 9, further comprising:
automatically determining the granularity of the domain by scaling the granularity levels of the starting period and the ending period.

11. The method of claim 1, further comprising:
providing the user a selection option for indicating at least one of the starting period and the ending period by adjusting a position of a slider along a time axis graphic.

12. The method of claim 1, further comprising:
receiving a user selection of a performance metric to be analyzed;
receiving a user selection of an output;
performing the analysis based on the selected performance metric and the domain; and
providing the output based on the selected output.

13. The method of claim 12, wherein the output includes at least one from a set of: a chart, a grid, and a three dimensional visualization.

14. The method of claim 12, wherein the output is selected from available outputs based on an attribute of performance metric data.

15. A system for automatically determining a domain for a performance metric based analysis, comprising:
a memory;
a processor coupled to the memory, wherein the processor is configured to execute instructions to perform actions including:
provide a selection option for indicating an ending period for the domain by one of: an explicit specification and a dynamic specification;
receive a user indication of the ending period;
provide a selection option for indicating a starting period for the domain by one of: an explicit specification and a lag period specification;
receive a user indication of the starting period;
determine a granularity for the domain based on granularity levels of the starting period and the ending period;
determine the domain based on the starting period, the ending period, and the granularity;
receive a user indication for at least one exclusion period; and
adjust the domain based on the at least one exclusion period.

16. The system of claim 15, wherein the processor is further configured to determine the granularity of the domain also based on a granularity of data associated with a selected performance metric.

17. The system of claim 15, wherein the processor is further configured to provide a selection option for indicating the at least one exclusion period by one of selecting from a collapsible tree list, explicit entry, and graphic selection.

18. The system of claim 15, wherein the processor is further configured to determine a summary value for the performance metric based on an average of periods in the domain.

19. A computer-readable storage medium with instructions stored thereon for automatically determining a domain for a performance metric based analysis, the instructions comprising:
receiving a user selection of a performance metric to be analyzed,
in response to providing a user interface for indicating an ending period for the domain by one of: an explicit specification and a dynamic specification, receiving a user indication of the ending period;
in response to providing a user interface for indicating a starting period for the domain by one of: an explicit specification and a lag period specification, receiving a user indication of the starting period;
determining a granularity for the domain based on granularity levels of the starting period and the ending period;
determining the domain based on the starting period, the ending period, and the granularity;
in response to receiving a user indication for an exclusion period, adjusting the domain based on the received exclusion period;
receiving a user selection of an output type;
performing the analysis based on a selected performance metric and the domain; and
providing the output based on the selected output type.

20. The computer-readable storage medium of claim 19, wherein the instructions further comprise providing a preview of the analysis that is updated automatically in response to receiving one of a starting period selection and an ending period selection.
